(19) United States
(12) Patent Application Publication
(10) Pub. No.: US 2010/0280830 A1
(43) Pub. Date: Nov. 4, 2010

(54) DECODER

(75) Inventors: Adriana Vasilache, Tampere (FI); Anssi Ramo, Tampere (FI); Lasse Laaksonen, Nokia (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/531,668

(22) PCT Filed: Mar. 16, 2007
(86) PCT No.: PCT/IB07/01851

§ 371 Date: May 20, 2010

(51) Int. Cl. G10L 21/00

(52) U.S. Cl. 704/500; 704/E19.001

(57) ABSTRACT

A decoder for decoding an encoded audio signal from a first part of the encoded audio signal, wherein the decoder is configured to: receive a first part of an encoded audio signal; determine at least one scaling factor dependent on the first part of the encoded audio signal; scale the first part of the encoded audio signal dependent on the at least one scaling factor to produce a scaled encoded audio signal; and decode the scaled encoded audio signal.

### FIELD OF THE INVENTION

The present invention relates to coding, and in particular, but not exclusively to speech or audio coding.

### BACKGROUND OF THE INVENTION

Audio signals, such as speech or music, are encoded for example in order to enable an efficient transmission or storage of audio signals.

Audio (encoders and decoders) codecs are used to represent audio based signals, such as music and background noise. These codecs typically do not utilise a speech model during their coding process, instead they tend to use more generic methods which are suited for representing most types of audio signals, including speech. Whereas speech codecs are usually optimised for speech signals, and can often operate at a fixed bit rate, and sampling rate.

Audio codecs can be configured to operate with varying bit rates over a wide range of sampling frequencies, and this is very often the preferred mode of operation for the many audio codecs such as the Advanced Audio Codec (AAC). Details of AAC can be found in the ISO/IEC 14496-3 Subpart 4 General Audio Coding (GA) technical specification. At lower bit rates, such audio codecs may work with speech or audio signals at a coding rate equivalent to a pure speech codec. In such circumstances, for speech at least, the speech codec will out perform a pure audio codec in terms of quality. This is due mainly to the utilisation by many speech codecs of the vocal tract model. However, at higher bit rates the performance of an audio codec may be good with any class of audio signal including music, background noise and speech.

A further audio coding option is an embedded variable rate speech or audio coding scheme, which is also referred as a layered or scalable coding scheme. Embedded variable rate audio or speech coding denotes an audio or speech coding scheme, in which a bit stream resulting from the coding operation is distributed into successive layers. A base or core layer which comprises of primary coded data generated by a core encoder is formed of the binary elements essential for the decoding of the binary stream, and determines a minimum quality of decoding. Subsequent layers make it possible to progressively improve the quality of the signal arising from the decoding operation, where each new layer brings new information. One of the particular features of layered based coding is the possibility offered of intervening at any level whatsoever of the transmission or storage chain, so as to delete a part of binary stream without having to include any particular indication to the decoder. The decoder uses the binary information that it receives and produces a signal of corresponding quality. For instance International Telecommunications Union Technical (ITU-T) standardisation aims at a wideband codec of 50 to 7000 Hz with bit rates from 8 to 32 kbps. The codec core layer will either work at 8 kbps or 12 kbps, and additional layers with quite small granularity will increase the observed speech and audio quality. The proposed layers will have as a minimum target at least five bit rates of 8, 12, 16, 24 and 32 kbps available from the same embedded bit stream.

By the very nature of layered, or scalable, based coding schemes the structure of the codecs tend to be hierarchical in form, consisting of multiple coding stages. Typically different coding techniques are used for the core (or base) layer and the additional layers. The coding methods used in the additional layers are then used to either code those parts of the signal which have not been coded by previous layers, or to code a residual signal from the previous stage. The residual signal is formed by subtracting a synthetic signal i.e. a signal generated as a result of the previous stage from the original.

Typically techniques used for low bit rate coding do not perform well at higher bit rates and vice versa. By adopting this hierarchical approach, a combination of coding methods make it possible to reduce the output to relatively low bit rates but retaining sufficient quality, whilst also producing good quality audio reproduction by using higher bit rates. This has resulted in structures using two different coding technologies. The codec core layer is typically a speech codec based on the Code Excited Linear Prediction (CELP) algorithm or a variant such as adaptive multi-rate (AMR) CELP and variable multi-rate (VMR) CELP.

Details of the AMR codec can be found in the 3GPP TS 26.090 technical specification, the AMR-WB codec 3GPP TS 26.190 technical specification, and the AMR-WB+ in the 3GPP TS 26.290 technical specification.

A similar scalable audio codec is the VMR-WB codec (Variable Multi-Rate Wide Band) was developed with regards to the CDMA 2000 communication system.

Details on the VMR-WB codec can be found in the 3GPP2 technical specification C.S0052-0. In a manner similar to the AMR family the source control VMR-WB audio codec also uses ACELP coding as a core coder.

The higher layers utilise techniques more akin to audio coding such as time frequency transformations as described in the prior art “Analysis/Synthesis Filter Bank Design Based on Time Domain Aliasing Cancellation” by J. P. Princen et al. (IEEE Transactions on ASSP, Vol ASSP-34, No. 5. October 1986)

However these higher level signals are not optimally coded. For example, the codec described in Ragot et al, “A 8-32 Kbit/s scalable wideband speech and audio coding candidate for ITU-T G.729EV standardisation” published in Acoustics, Speech and Signal Processing 2006, ICASSP 2006 proceedings, 2006 IEEE International Conference Volume 1, page I-1 to I-4 describes scalable wideband audio coding.

A further example of an audio codec is from US patent application published as number 2006/0036435. This audio codec describes where the number of coding bits per frequency parameter is selected dependent on the perceptual importance of the frequency. Thus parameters representing ‘perceptually more important’ frequencies are coded using more bits than the number of bits used to code ‘perceptually less important’ frequency parameters. Typically in an audio signal this means that lower frequencies, which are perceived to be more perceptually important than higher ones, are coded using more bits.

In scalable layered audio codecs of such type it is normal practice to arrange the various coding layers in order of perceptual importance. Whereby the bits associated with the quantisation of the perceptually important frequencies, which is typically the lower frequencies, is assigned to a lower and therefore perceptually more important coding layer. Consequently where the channel or storage chain is constrained, the decoder may not receive all coding layers. Therefore the higher coding layers, which are typically associated with the higher frequencies of the coded signal, are not decoded. This has the undesired effect of changing the timbre of the signal by making it perceptually dull in character.

### SUMMARY OF THE INVENTION

This invention proceeds from the consideration that coding an audio signal as a number of layers results in the undesirable effect of making the resulting audio signal dull in timbre. This is a consequence of stripping out higher coding layers during the transmission or storage chain, thereby removing the energy present in the higher frequencies.

It would be possible to emphasise any remaining high frequency components, in order to return some of the lost brightness to the timbre of the received audio signal. While this can increase the energy in the higher frequencies, the naturalness of the decoded signal can be compromised to some extent. This approach implies that there is a trade-off between the emphasis of the higher frequencies and the loss of naturalness in the decoded signal.

Embodiments of the present invention aim to address the above problem.

According to the present invention there is provided a decoder for decoding an encoded audio signal from a first part of the encoded audio signal, wherein the decoder is configured to: receive a first part of an encoded audio signal; determine at least one scaling factor dependent on the first part of the encoded audio signal; scale the first part of the encoded audio signal dependent on the at least one scaling factor to produce a scaled encoded audio signal; and decode the scaled encoded audio signal.

The encoded audio signal may comprises at least one set of spectral values, and the first part of the encoded audio signal comprises: at least one sub-set of spectral values, each sub-set of spectral values associated with one of the at least one set of spectral values; and at least one set scaling factor, each set scaling factor being associated with one of the at least one set of spectral values.

Each of the at least one scaling factor is preferably associated with one of the at least one set of spectral values, wherein the decoder is preferably configured to scale the sub-set of spectral values associated with one of the at least one set of spectral values by the respective scaling factor.

Each scaling factor may comprise a first term dependent on the respective sub-set of spectral values and a second term dependent on the first term and the respective set scaling factor.

The first term of the scaling factor may comprise the total spectral energy value of the respective sub-set of spectral values.

The total spectral energy value of the respective sub-set of spectral values may comprise at least one of: a combination of an absolute value of each spectral value of the respective sub-set of spectral values; and a combination of a squared value of each spectral value of the respective sub-set of spectral values.

Each set scaling factor may comprise at least one of: the average energy per spectral value for the respective set of spectral values; the average energy per spectral value for all sets of spectral values.

The second term may comprise the combination of the first term and the product of the respective set scaling factor and a multiplier.

The decoder is preferably configured to determine the value of the multiplier by subtracting the number of spectral values in the respective sub-set of spectral values from the number of spectral values in the set of spectral values.

The decoder may further be configured to determine the number of spectral values in a set of spectral values; and for each of the number of spectral value in a set of spectral values the decoder is preferably configured to: determine whether each of the number of spectral values is within the sub-set of spectral values.

The decoder may be further configured to accumulate the second term by the set scaling factor when the decoder determines that the spectral value is not within the sub-set of spectral values.

The decoder may be further configured to accumulate the first term and the second term by a respective sub-set spectral value when the decoder determines that the spectral value is in the sub-set of spectral values.

Each scaling factor may comprise the first term normalised by the second term.

Each spectral value may comprise a discrete orthogonal transform basis vector weighting coefficient.

The discrete orthogonal transform may comprise a modified discrete cosine transform.

Each scaling factor may comprise the ratio of the first term to the second term.

The received encoded audio signal may comprise individual coding layers.

The at least one scaling factor may be an emphasis scaling factor.

According to a second aspect of the invention there is provided a method for decoding an encoded audio signal from a first part of the encoded audio signal, wherein the method comprises: receiving a first part of an encoded audio signal; determining at least one scaling factor dependent on the first part of the encoded audio signal; scaling the first part of the encoded audio signal dependent on the at least one scaling factor to produce a scaled encoded audio signal; and decoding the scaled encoded audio signal.

The encoded audio signal may comprise at least one set of spectral values, and the first part of the encoded audio signal may comprise: at least one sub-set of spectral values, each sub-set of spectral values associated with one of the at least one set of spectral values; and at least one set scaling factor, each set scaling factor being associated with one of the at least one set of spectral values.

Each of the at least one scaling factor may be associated with one of the at least one set of spectral values, wherein the scaling the first part of the encoded audio signal may comprise scaling the sub-set of spectral values associated with one of the at least one set of spectral values by the respective scaling factor.

Determining at least one scaling factor may comprise determining a first term dependent on the respective sub-set of spectral values and determining a second term dependent on the first term and the respective set scaling factor.

Determining the first term may comprise determining the total spectral energy value of the respective sub-set of spectral values.

Determining the total spectral energy value of the respective sub-set of spectral values may comprise at least one of: determining a combination of an absolute value of each spectral value of the respective sub-set of spectral values; and determining a combination of a squared value of each spectral value of the respective sub-set of spectral values.

Each set scaling factor may comprise at least one of: the average energy per spectral value for the respective set of spectral values; the average energy per spectral value for all sets of spectral values.

Determining the second term may comprise combining the first term and a product of the respective set scaling factor and a multiplier.

The method may further comprise determining the value of the multiplier by subtracting the number of spectral values in the respective sub-set of spectral values from the number of spectral values in the set of spectral values.

The method may further comprise: determining a number of spectral values in a set of spectral values; and for each of the number of spectral value in a set of spectral values the method comprises determining whether the spectral value is within the sub-set of spectral values.

The method may further comprise accumulating the second term by the set scaling factor when the spectral value is determined to not be within the sub-set of spectral values.

The method may further comprise accumulating the first term and the second term by the respective sub-set spectral value when the spectral value is in the sub-set of spectral values.

Determining each scaling factor may comprise normalising the first term by the second term.

Each spectral value is preferably a discrete orthogonal transform basis vector weighting coefficient.

The discrete orthogonal transform is preferably a modified discrete cosine transform.

Determining each scaling factor may comprise the ratio of the first term to the second term.

The received encoded audio signal may comprise individual coding layers.

The at least one scaling factor is preferably an emphasis scaling factor.

According to a third aspect of the invention there is provided an apparatus comprising a decoder as described above.

According to a fourth aspect of the invention there is provided an electronic device comprising a decoder as described above.

According to a fifth aspect of the invention there is provided a computer program product configured to perform a method for decoding an encoded audio signal from a first part of the encoded audio signal, wherein the method comprises: receiving a first part of an encoded audio signal; determining at least one scaling factor dependent on the first part of the encoded audio signal; scaling the first part of the encoded audio signal dependent on the at least one scaling factor to produce a scaled encoded audio signal; and decoding the scaled encoded audio signal.

According to a sixth aspect of the invention there is provided a decoder for decoding an encoded audio signal from a first part of the encoded audio signal, wherein the decoder is configured to: means for receiving a first part of an encoded audio signal; means for determining at least one scaling factor dependent on the first part of the encoded audio signal; means for scaling the first part of the encoded audio signal dependent on the at least one scaling factor to produce a scaled encoded audio signal; and means for decoding the scaled encoded audio signal.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio decoder according to an embodiment of the present invention;

FIG. 3 shows a flow diagram illustrating the operation of an embodiment of the audio decoder according to the present invention;

FIG. 4 shows a flow diagram illustrating part of the operation shown in FIG. 3, according to a first embodiment of the invention; and

FIG. 5 shows a flow diagram illustrating part of the operation shown in FIG. 3, according to a second embodiment of the invention.

### DESCRIPTION OF PREFERRED EMBODIMENTS OF THE INVENTION

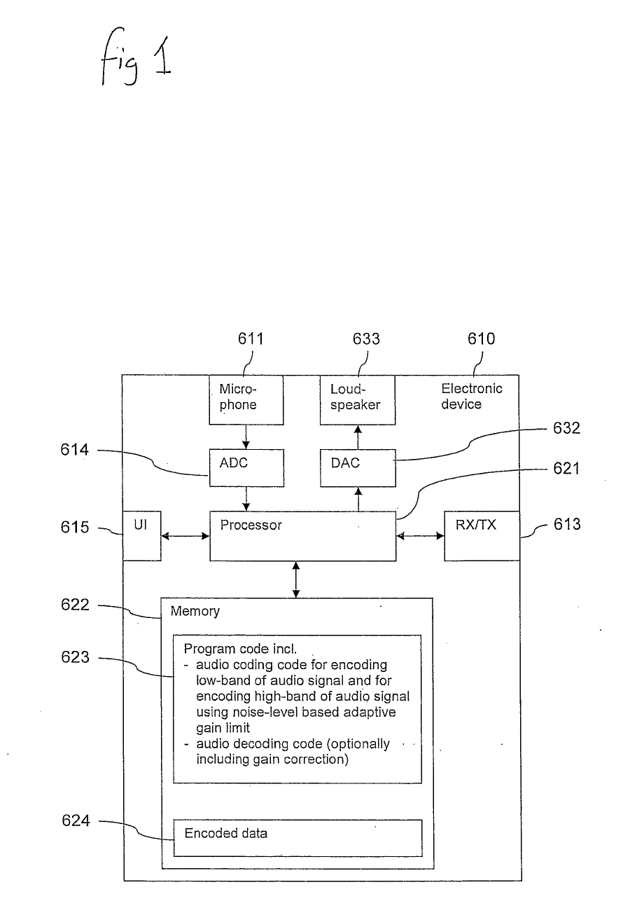

The following describes in more detail possible codec mechanisms for the provision of adaptive or variable audio codecs. In this regard reference is first made to FIG. 1 schematic block diagram of an exemplary electronic device 610, which may incorporate a codec according to an embodiment of the invention.

The electronic device 610 may for example be a mobile terminal or user equipment of a wireless communication system.

The electronic device 610 comprises a microphone 611, which is linked via an analogue-to-digital converter 614 to a processor 621. The processor 621 is further linked via a digital-to-analogue converter 632 to loudspeakers 633. The processor 621 is further linked to a transceiver (TX/RX) 613, to a user interface (UI) 615 and to a memory 622.

The processor 621 may be configured to execute various program codes. The implemented program codes comprise an audio encoding code for encoding a lower frequency band of an audio signal and a higher frequency band of an audio signal. The implemented program codes 623 further comprise an audio decoding code. The implemented program codes 623 may be stored for example in the memory 622 for retrieval by the processor 621 whenever needed. The memory 622 could further provide a section 624 for storing data, for example data that has been encoded in accordance with the invention.

The encoding and decoding code may in embodiments of the invention be implemented in hardware or firmware.

The user interface 615 enables a user to input commands to the electronic device 610, for example via a keypad, and/or to obtain information from the electronic device 610, for example via a display. The transceiver 613 enables a communication with other electronic devices, for example via a wireless communication network.

It is to be understood again that the structure of the electronic device 610 could be supplemented and varied in many ways.

A user of the electronic device 610 may use the microphone 611 for inputting speech that is to be transmitted to some other electronic device or that is to be stored in the data section 624 of the memory 622. A corresponding application has been activated to this end by the user via the user interface 615. This application, which may be run by the processor 621, causes the processor 621 to execute the encoding code stored in the memory 622.

The analogue-to-digital converter 614 converts the input analogue audio signal into a digital audio signal and provides the digital audio signal to the processor 621.

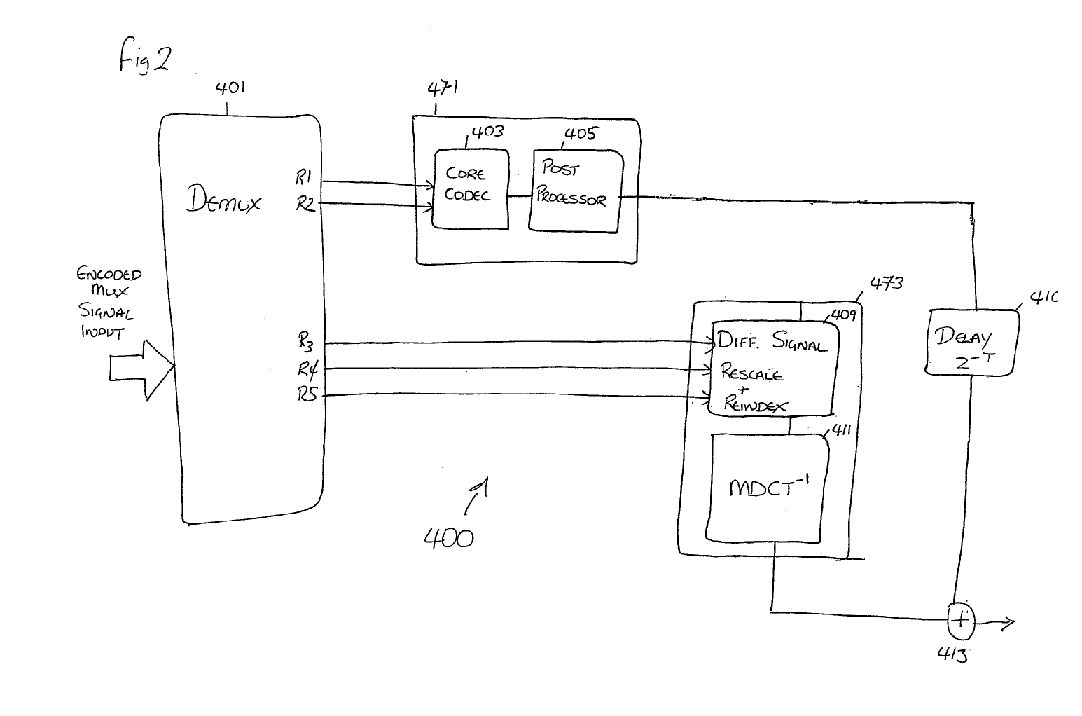

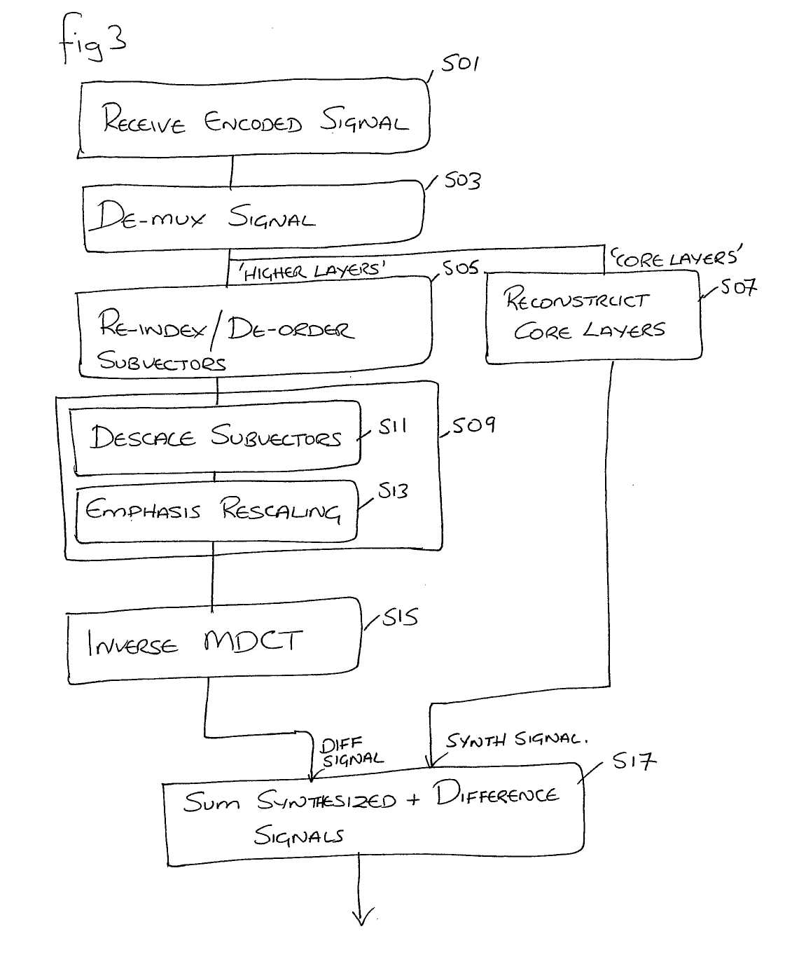

The processor 621 may then process the digital audio signal in the same way as described with reference to FIGS. 2 and 3.

The resulting bit stream is provided to the transceiver 613 for transmission to another electronic device. Alternatively, the coded data could be stored in the data section 624 of the memory 622, for instance for a later transmission or for a later presentation by the same electronic device 610.

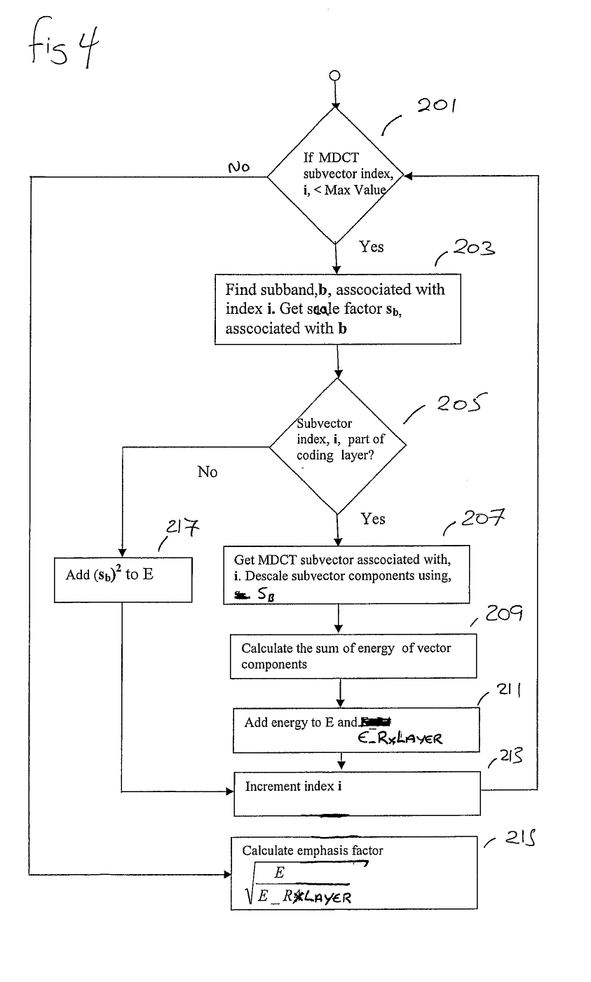

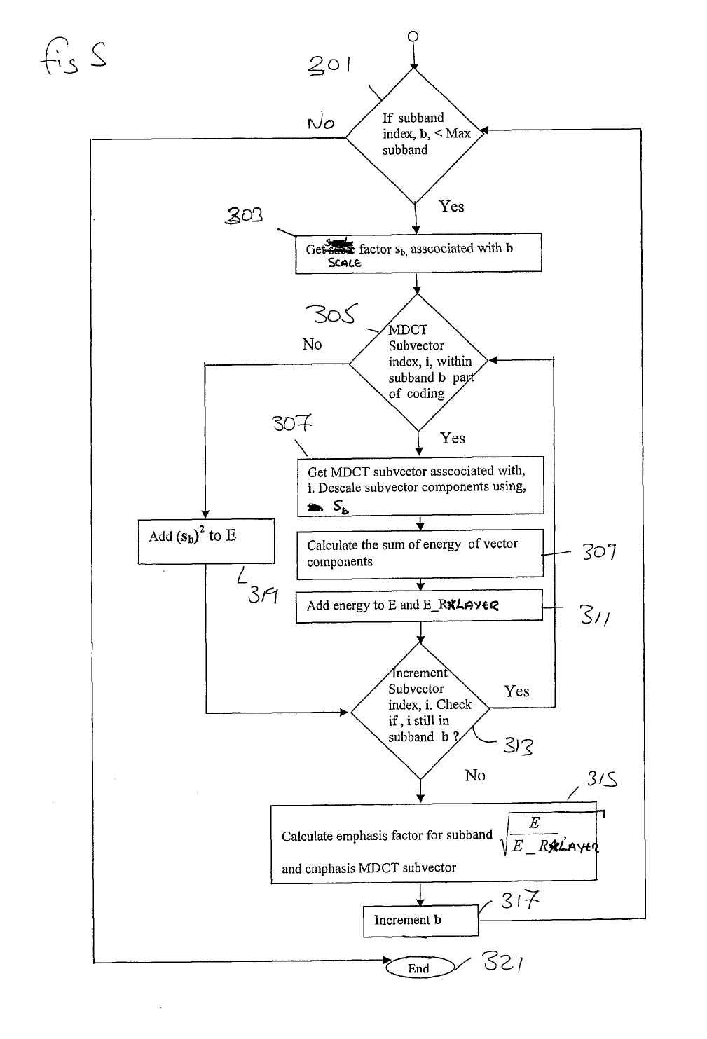

The electronic device 610 could also receive a bit stream with correspondingly encoded data from another electronic device via its transceiver 613. In this case, the processor 621 may execute the decoding program code stored in the memory 622. The processor 621 decodes the received data, for instance in the same way as described with reference to FIGS. 4 and 5, and provides the decoded data to the digital-to-analogue converter 632. The digital-to-analogue converter 632 converts the digital decoded data into analogue audio data and outputs them via the loudspeakers 633. Execution of the decoding program code could be triggered as well by an application that has been called by the user via the user interface 615.

The received encoded data could also be stored instead of an immediate presentation via the loudspeakers 633 in the data section 624 of the memory 622, for instance for enabling a later presentation or a forwarding to still another electronic device.

It would be appreciated that the schematic structures described in FIG. 2 and the method steps in FIGS. 3 to 5 represent only a part of the operation of a complete audio codec as exemplarily shown implemented in the electronic device shown in FIG. 1. The general operation of audio codecs is known and features of such codecs which do not assist in the understanding of the operation of the invention are not described in detail.

The embodiment of the invention audio codec comprises an encoder part—which converts audio signals into encoded signals and a decoder part—which converts encoded signals into replicas of the audio signal originally coded in the encoder part.

The encoder is not described in detail within the application. However further information on encoders may be found in the co-pending applications [PWF reference 314217/KCS/GJS and 314261/KCS/GJS]. The encoder typically receives the audio signal and encodes the audio signal as a series of layers. The ‘core’ layers typically comprise information related to parameters generated from the core codec. The ‘higher’ layers typically comprise information related to the difference between the original audio signal and a synthesised copy of the audio signal generated by decoding the ‘lower layer’ parameters. The ‘core layers’ and at least some of the ‘higher layers’ are then multiplexed together and passed to the decoder for decoding.

With respect to FIG. 2, an example of a decoder 400 for the codec as implemented in embodiments of the invention is shown. The decoder 400 receives an encoded signal and outputs a replica of the original audio output signal.

The decoder comprises a demultiplexer 401, which receives the encoded signal and outputs a series of data streams. The demultiplexer 401 is connected to a core decoder 471 for passing the core level bitstreams (which can be referred to as the R1 and R2 layers in this embodiment).

Although the above embodiments have been described as producing core levels or layers described above as the R1 and R2 layers, it is to be understood that further embodiments may adopt differing number of core encoding layers, thereby being capable of achieving different levels of granularity in terms of both bit rate and audio quality.

The demultiplexer 401 is also connected to a difference decoder 473 for outputting the higher level bitstreams (which can be referred to as the R3, R4, and R5 in this embodiment). The core decoder 471 may be connected to connected to a summing device 413 via a delay element 410 which also receives a synthesized signal.

The higher coding layers (referred to as R3, R4 and/or R5) encode the signal at a progressively higher bit rate and quality level. It is to be understood that further embodiments may adopt differing number of encoding layers, thereby achieving a different level of granularity in terms of both bit rate and audio quality.

The core decoder may be connected to a synthesized signal decoder (not shown in FIG. 2). The synthesized signal decoder (not shown in FIG. 2) may then be connected to the difference decoder 473 for passing locally generated scaling factors for each sub-band from the core level decoder synthetic signal. These factors typically take the form of an energy measure, including inter alia, root mean square, average energy, peak magnitude. This value may form a scaling factor for a sub-band. However, it is equally likely to be used in conjunction with other values which may be transmitted as part of the encoded bit stream, to form a combined scaling factor.

The difference decoder 473 is also connected to the summing device 413 to pass a difference signal to the summing device. The summing device 413 has an output which is an approximation of the original signal.

The demultiplexer 401 receives the encoded signal, shown in FIG. 3 by step 501.

The demultiplexer 401 is further arranged to separate the core level signals (R1 and/or R2) from the higher level signals (R3, R4, and/or R5). This step is shown in FIG. 3 in step 503.

The core level signals are passed to the core decoder 471 and the higher level signals passed to the difference decoder 473.

The core decoder 471, using the core codec 403, receives the core level signal (the core codec encoded parameters) discussed above and is configured to perform a decoding of these parameters to produce an output similar to that produced by a synthesized signal output by a core codec 203 in an encoder.

For embodiments where the scalable coding systems core codec is operating at a lower sampling rate than the original input signal, the encoder may have performed pre-processing on the audio signal prior to the application of the core-codec and therefore also perform post-processing on a synthesized signal to return the synthesized signal to the same sample rate as the original audio signal. The synthesized signal may for example be up-sampled by the post processor 405 to produce a synthesized signal similar to the synthesized signal output by the core encoder 271 in the encoder 200.

In embodiments where the scalable layered coding systems core codec is operating at the same sampling rate as the original, the post processing stage may be omitted from the decoder.

This synthesized signal is passed via the delay element 410 to the summing device 413. In embodiments of the invention, where for example the difference decoder performs a scaling or re-ordering dependent on parameters generated from the synthesized signal, the synthesized signal may be then also passed to the difference decoder 473 as shown in FIG. 2 by the dashed connection between the core decoder 471 and the difference decoder 473.

The generation of the synthesized signal step is shown in FIG. 5 by step 505c.

The difference decoder 473 passes the higher level signals to the difference processor 409.

The difference processor 409 demultiplexes from the higher level signals the received scale factors and the quantized sub-vectors whose constituent components are formed from the scaled frequency coefficients, such as MDCT inter alia.

The difference processor 409 may re-index the received scale factors and the quantized sub-vectors. The re-indexing returns the scale factors and the quantized sub-vectors to the order prior to an indexing carried out in an encoder.

The difference processor 409 may also de-interlace or de-order the sub-vectors according to any de-interlacing or de-ordering process. This process is carried out to return the order of the sub-vectors to the order prior to any interlacing or re-ordering carried out in an encoder.

The re-indexing/de-ordering is shown in FIG. 3 as step 505.

The scaling of the sub-vectors in embodiments of the invention may comprise at least two separate scaling actions.

The difference processor 409 may perform a de-scaling action. The de-scaling of the sub-vectors modifies the values of each of the sub-vectors so that each sub-vector approximates the value of the related sub-vector prior to any encoder scaling.

The de-scaling of the sub-vectors is shown in FIG. 3 in step 509.

It would be appreciated that the de-scaling factors may be generated by any method. For example the de-scaling factors may be non time varying predetermined factors, or are time varying factors which are passed to the decoder or calculated from information passed with the higher level signal (for example the received scale factors described above). In other embodiments of the invention the de-scaling factors are calculated from the core ‘lower’ layer parameters or from the synthesized signal.

Furthermore it would be appreciated that a de-scaling may comprise any number or combination of de-scaling actions with different factors used in each separate de-scaling action.

The de-scaling action is shown in FIG. 3 by step 511.

The difference processor 409 furthermore performs an emphasis rescaling of the sub-vectors.

In a first embodiment of the invention a single emphasis factor is calculated based on factors representing the ratio of the energy of the original signal to the energy in the reconstructed signal.

In a first embodiment of the invention the energy of the original signal is estimated from the quantized sub-band scale factors. The quantized sub-band scale factors are themselves generated by the difference processor 409 by dequantizing the codebook indices representing the sub-band scale factors. In the same embodiment the energy of the reconstructed signal is estimated from the combined effect of a subset of scale factors whose members are dependent on the MDCT sub-vectors present over the frequency range.

Each MDCT sub-vector index is a reference to a MDCT sub-vector, whose constituent components are frequency components arranged in an ascending order of frequency.

With respect to FIG. 4, an example of the operation of the first embodiment of the invention in a decoder (together with the de-scaling process) is shown in further detail. In this example the sub-vectors are grouped into sub-bands of sub-vectors. In the example below an optional predetermined scaling process is shown where in the encoder each sub-vector within a sub-band, b, has been scaled by the same factor S_{b}. The steps associated with this scaling may in other embodiments of the invention be replaced by other de-scaling steps or may be missing from the process.

In the first step 201, the current sub-vector index is checked to see if it is a valid index value, i.e. is it below the maximum index value.

If the sub-vector index is not valid the method moves to step 215 otherwise if the current sub-vector index is valid then the method moves to step 203.

In step 203 the sub-band, b, associated with the index, i, is determined. The scaling factor, S_{b}, associated with the sub-band is also determined.

In the following step, step 205, the sub-vector index, i, is compared against a list of received frequency sub-vectors to determine whether the current index is part of the current coding layer—in other words was a MDCT sub-vector received representing the same index or frequency index.

If there is a sub-vector representing the current index, i, the method passes to step 207, else the method passes to step 217.

In step 207, the MDCT sub-vector associated with the current index is recovered. The MDCT sub-vector is then descaled using the scaling factor S_{b}.

In the following step, step 209, the sum of the energy of the vector components is calculated. For example each vector component is squared and summed to give a mean square energy value for each MDCT sub-vector.

In the following step, step 211, the sum of the energy of the vector components calculated in step 209 is added to the current running total energy value E and the current running energy value for the current coding layer E_RxLayer. E may be seen to represent the energy of the frequency coefficients present in the signal before higher layers were stripped from the bitstream. E_RxLayer may be seen to represent the energy of the frequency coefficients present in the received coding layers. It is to be appreciated that E and E_RxLayer may represent respective energy factors calculated over a frequency range which is determined by the number of sub-band groups.

In the following step, step 213, the index is incremented and the method is returned to step 201.

In the step 217, the step following the step 205, where no MDCT sub-vector was received representing the same index or frequency index, the scale factor for the index S_{b} is squared and added to the current running total energy value E. The method then passes to step 213 where the index is incremented and the method returned to step 201.

In step 215, the step following step 201 determining that the index, i, is not a valid index (i.e. the index has reached its maximum value), the method then calculates the emphasis factor. In the first embodiment of the invention this emphasis is the square root of the ratio of the total energy E divided by the energy value of the coding layer E_RxLayer.

This emphasis factor is then applied to those constituent components of the of the MDCT sub-vectors over which the factor is calculated.

This method may be written as part of a c-programming language code such as that shown below. In this instance the emphasis factor is calculated for the energy of the frequency coefficients received in the R4 layer.

void

| | |
|---|---|
| enhance_hf(float * y_norm, | /* decoded scaled MDCT coefficients for a frame */ |
| int start, | /* first sub vector to be applied the enhancement */ |
| float * scales, | /* quantized additional scales for subbands */ |
| int * read_vect) | /* flags indicating which sub vectors have been read in R4 |
| layer */ | |
| { | |

| | | |
|---|---|---|
| float | energy = 0.0, | /* approximation of the energy of the original signal */ |
| | energy_R4=0.0; | /* approximation of the energy of the reconstructed |

```
signal */
  float factor;
  int i,b;
  for(i=start;i<MAX_NO_VECT;i++) /* MAX_NO_VECT is the maximum number of sub
  vectors */
{
      /* find to which subband the sub vector i belongs to */
      b = find_subband(band_bin, BANDS, i*SPACE_DIM);
      /* if the sub vector is read in R4*/
      if (read_vect[i] == 1)
      {
        energy += scales[b]*scales[b];
        energy_R4 += scales[b]*scales[b];
      }
      else /* update only the energy corresponding to the original signal */
        energy += scales[b]*scales[b];
  }
  factor = 0.7*sqrtf(energy/energy_R4);
  for(i=start;i<MAX_NO_VECT;i++)
  {
      if (read_vect[i] == 1)
      /* multiply the reconstructed sub vector in order to increase its energy */
        vec_mul_s(&y_norm[i*SPACE_DIM], factor, &y_norm[i*SPACE_DIM],
SPACE_DIM);
  }
  return;
}
```

In further embodiments of the invention the emphasis factor described above may be modified by a further multiplication factor. This factor may be subjectively chosen or may be chosen by the difference processor to ‘tune’ the audio decoded signal. Typically the further multiplication factor is a value less than 1.

With regards to FIG. 5, an example of the operation of a second embodiment of the invention in a decoder (together with the de-scaling process) is shown in further detail. In this example the sub-vectors are also grouped into sub-bands of sub-vectors. In the example below an optional predetermined scaling process is shown where in the encoder each sub-vector within a sub-band, b, has been scaled by the same factor S_{b}. The steps associated with this scaling may in other embodiments of the invention be replaced by other de-scaling steps or may be missing from the process.

In the following example both a sub-band index, b, and a sub-vector index, i, are defined. The sub-vector index may be independent but capable of being mapped to the sub-band index or may be a sub-division of the sub-band index.

In the first step 301, the current sub-band index, b, is checked to see if it is a valid index value, i.e. is it less than or equal to the maximum sub-band index value.

If the sub-band index is not valid the method moves to step 321 and the method ends otherwise if the current sub-band index is valid then the method moves to step 303.

In step 303 the scaling factor, S_{b}, associated with the sub-band index, b, is determined.

In the following step, step 305, the sub-vector index, i, is compared against a list of received frequency sub-vectors to determine whether the current sub-vector index is part of the current coding layer—in other words was a MDCT sub-vector received representing the same sub-vector index.

If there is a MDCT sub-vector representing the current index, i, the method passes to step 307, else the method passes to step 319.

In step 307, the MDCT sub-vector associated with the current sub-vector index is recovered. The MDCT sub-vector is then descaled using the scaling factor S_{b}.

In the following step, step 309, the sum of the energy of the vector components is calculated. For example each vector component is squared and summed to give a mean square energy value for each MDCT sub-vector.

In the following step, step 311, the sum of the energy of the vector components calculated in step 309 is added to the current running total energy value E and the current running energy value for the current coding layer E_Rxlayer.

In the following step, step 313, the index is incremented. Furthermore the incremented sub-vector index, i, is checked to determine whether the sub-vector is within the current sub-band index, b. If the incremented sub-vector is in the current sub-band the method passes to step 305, if not the method passes to step 315.

In the step 319, the step following the step 305, where no MDCT sub-vector was received representing the same index or frequency index, the scale factor for the index S_{b} is squared and added to the current running total energy value E. The method then passes to step 313 where the sub-vector index is incremented and checked to determine whether the sub-vector is within the current sub-band index, b.

In step 315, the step following step 313, the method then calculates the emphasis factor for the current sub-band, b. In one embodiment of the invention this emphasis is the square root of the ratio of the total energy E divided by the energy value of the coding layer E_Rxlayer.

This ratio is then applied to all of the MDCT sub-vectors within the sub-band.

In step 317, the following step, the method then increments the sub-band index b and returns the method to step 301, where the method checks to see if there are any more sub-bands to process.

This method for the exemplary embodiment may also be represented in c by the following programming code. In this instance the emphasis factor is calculated for the energy of the frequency coefficients received in the R4 layer.

| | |
|---|---|
| void | |
| enhance_hf(float * y_norm, | /* decoded scaled MDCT coefficients for a frame */ |
| int start, | /* first sub vector to be applied the enhancement */ |
| float * scales, | /* quantized additional scales for subbands */ |
| int * read_vect) | /* flags indicating which sub vectors have been read in R4 |
| layer */ | |
| { | |

| | | |
|---|---|---|
| float | energy[BANDS], | /* approximation of the energy of the original signal */ |
| | energy_R4[BANDS]; | /* approximation of the energy of the reconstructed |

```
signal */
  float factor[BANDS];
  int i,b;
  /* initializations to 0 */
  vec_set(energy, 0.0, BANDS);
  vec_set(energy_R4, 0.0, BANDS);
  /* initializations to 1.0 */
  vec_set(factor, 1.0, BANDS);
  for(i=start;i<MAX_NO_VECT;i++) /* MAX_NO_VECT is the maximum number of sub
vectors */
  {
      /* find to which subband the sub vector i belongs to */
      b = find_subband(band_bin, BANDS, i*SPACE_DIM);
      /* if the sub vector is read in R4*/
      if (read_vect[i] == 1)
      {
          energy[b] += scales[b]*scales[b];
          energy_R4[b] += scales[b]*scales[b];
      }
      else /* update only the energy corresponding to the original signal */
          energy[b] += scales[b]*scales[b];
  }
  for(i=0;i<BANDS;i++)
      if (energy_R4[b] > 0.0)
              factor[b] = 0.7*sqrtf(energy[b]/energy_R4[b]);
  for(i=start;i<MAX_NO_VECT;i++)
  {
      if (read_vect[i] == 1){
            /* find to which subband the sub vector i belongs to */
      b = find_subband(band_bin, BANDS, i*SPACE_DIM);
      /* multiply the reconstructed sub vector in order to increase its energy */
        vec_mul_s(&y_norm[i*SPACE_DIM], factor[b], &y_norm[i*SPACE_DIM],
SPACE_DIM);
      }
  }
  return;
}
```

This second embodiment is specifically advantageous as it is able to provide emphasis for each separate sub-band separately. In embodiments of the invention where sub-vectors are interlaced the reduction of the higher level signals would result in at least some information for each of the sub-bands being received and thus a wider bandwidth of difference signals being reconstructed.

However even where interlacing is not employed the embodiments described above are advantageous as they are able to at least partially mitigate the lost energy information by emphasising the values of any remaining MDCT sub-vectors. Such embodiments as described in relation to the invention may therefore accentuate the received higher frequencies by a scaling factor to an extent such that the scaling factor used is related to the energy difference between the original signal spectrum and the received signal spectrum.

The embodiments shown above show a method for calculating the emphasis factor for each sub-band on a vector by vector basis. However as would be appreciated by the person skilled in the art other methods of calculation of the emphasis factor may be employed. For example the E_RxLayer value may be calculated as shown above when the index is part of the coding layer. The E value may then be calculated by taking the E_RxLayer value and then adding this value to the product of the S_{b}² value to the number of times that the sub-vector index is not part of the coding layer.

This emphasis process is shown in FIG. 3 in step 513.

The output from the emphasis process is then passed to an inverse MDCT processor 411 which outputs a time domain sampled version of the difference signal.

This inverse MDCT process is shown in FIG. 5 as step 515.

The time domain sampled version of the difference signal is then passed from the difference decoder 473 to the summing device 413 which in combination with the delayed synthesized signal from the coder decoder 471 via the digital delay 410 produces a copy of the original digitally sampled audio signal.

This combination is shown in FIG. 5 by the step 517.

The above described a procedure using the example of a VMR audio codec. However, similar principles can be applied to any other multi-rate speech or audio codec.

In the example provided above of the present invention the MDCT (and IMDCT) is used to convert the signal from the time to frequency domain (and vice versa). As would be appreciated any other appropriate time to frequency domain transform with an appropriate inverse transform may be implemented instead. Thus any orthogonal discrete transform may be implemented. Non limiting examples of other transforms comprise: a discrete Fourier transform (DFT), a fast Fourier transform (FFT), a discrete cosine transform (DCT-I, DCT-II, DCT-III, DCT-IV etc), and a discrete sine transform (DST).

The embodiments of the invention described above describe the codec 10 in terms of a decoders 400 apparatus separate from an encoder in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 610, it would be appreciated that the invention as described below may be implemented as part of any variable rate/adaptive rate audio (or speech) codec where the difference signal (between a synthesized and real audio signal) may be quantized. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. An apparatus comprising:
a decoder configured to:
receive a first part of an encoded audio signal;
determine at least one scaling factor based at least in part on the first part of the encoded audio signal;
scale the first part of the encoded audio signal based at least in part on the at least one scaling factor to produce a scaled encoded audio signal; and
decode the scaled encoded audio signal.

2. The apparatus as claimed in claim 1, wherein the encoded audio signal comprises at least one set of spectral values, and the first part of the encoded audio signal comprises:
at least one sub-set of spectral values, each sub-set of spectral values associated with one of the at least one set of spectral values; and
at least one set scaling factor, each set scaling factor being associated with one of the at least one set of spectral values.

3. The apparatus as claimed in claim 2, wherein each of the at least one scaling factor is associated with one of the at least one set of spectral values, wherein the decoder is configured to scale the sub-set of spectral values associated with one of the at least one set of spectral values by the respective scaling factor.

4. (canceled)

5. The apparatus as claimed in claim 3, wherein the first term of the scaling factor comprises the total spectral energy value of the respective sub-set of spectral values; and wherein the total spectral energy value if the respective sub-set of spectral values comprises at least one of:
a combination of an absolute value of each spectral value of the respective sub-set of spectral values; and
a combination of a squared value of each spectral value of the respective sub-set of spectral values.

6. (canceled)

7. A decoder as claimed in claim 5, wherein each set scaling factor comprises at least one of:
the average energy per spectral value for the respective set of spectral values;
the average energy per spectral value for all sets of spectral values.

8. The apparatus as claimed in claim 5, wherein the second term comprises the combination of the first term and the product of the respective set scaling factor and a multiplier, and wherein the decoder is further configured to determine the value of the multiplier by subtracting the number of spectral values in the respective sub-set of spectral values from the number of spectral values in the set of spectral values

9. (canceled)

10. The apparatus as claimed in claim 3, further configured to determine the number of spectral values in a set of spectral values; and for each of the number of spectral value in a set of spectral values the decoder is configured to:
determine whether each of the number of spectral values is within the sub-set of spectral values;
accumulate the second term by the set scaling factor when the decoder determines that the spectral value is not within the sub-set of spectral values; and
accumulate the first term and the second term by a respective sub-set spectral value when the decoder determines that the spectral value is in the sub-set of spectral values,

11-12. (canceled)

13. The apparatus as claimed in claim 3, wherein each scaling factor comprises the first term normalised by the second term.

14-15. (canceled)

16. The apparatus as claimed in claim 1, wherein each scaling factor comprises the ratio of the first term to the second term, wherein the received encoded audio signal comprises individual coding layers and wherein the at least one scaling factor is an emphasis scaling factor.

17-18. (canceled)

19. A method comprising:
receiving a first part of an encoded audio signal;
determining at least one scaling factor based at least in part on the first part of the encoded audio signal;
scaling the first part of the encoded audio signal based at least in part on the at least one scaling factor to produce a scaled encoded audio signal; and
decoding the scaled encoded audio signal.

20. A method as claimed in claim 19, wherein the encoded audio signal comprises at least one set of spectral values, and the first part of the encoded audio signal comprises: at least one sub-set of spectral values, each sub-set of spectral values associated with one of the at least one set of spectral values; and at least one set scaling factor, each set scaling factor being associated with one of the at least one set of spectral values.

21. A method as claimed in claim 20, wherein each of the at least one scaling factor is associated with one of the at least one set of spectral values, wherein the scaling the first part of the encoded audio signal comprises scaling the sub-set of spectral values associated with one of the at least one set of spectral values by the respective scaling factor; and wherein determining at least one scaling factor comprises determining a first term dependent on the respective sub-set of spectral values and determining a second term dependent on the first term and the respective set scaling factor.

22. (canceled)

23. A method as claimed in claim 22, wherein determining the first term comprises determining the total spectral energy value of the respective sub-set of spectral values, and wherein determining the total spectral energy value of the respective sub-set of spectral values comprises at least one of:
determining a combination of an absolute value of each spectral value of the respective sub-set of spectral values; and
determining a combination of a squared value of each spectral value of the respective sub-set of spectral values.

24. (canceled)

25. A method as claimed in claim 23, wherein each set scaling factor comprises at least one of:
the average energy per spectral value for the respective set of spectral values;
the average energy per spectral value for all sets of spectral values.

26. A method as claimed in claim 22, wherein determining the second term comprises combining the first term and a product of the respective set scaling factor and a multiplier, and wherein the method further comprises determining the value of the multiplier by subtracting the number of spectral values in the respective sub-set of spectral values from the number of spectral values in the set of spectral values.

27. (canceled)

28. A method as claimed in claim 22, further comprising:
determining a number of spectral values in a set of spectral values; and for each of the number of spectral value in a set of spectral values the method comprises determining whether the spectral value is within the sub-set of spectral values;
accumulating the second term by the set scaling factor when the spectral value is determined to not be within the sub-set of spectral values;
accumulating the first term and the second term by the respective sub-set spectral value when the spectral value is in the sub-set of spectral values.

29-30. (canceled)

31. A method as claimed in claim 22, wherein determining each scaling factor comprises normalising the first term by the second term.

32-33. (canceled)

34. A method as claimed in claim 19, wherein determining each scaling factor comprises the ratio of the first term to the second term, wherein the received encoded audio signal comprises individual coding layers, and wherein the at least one scaling factor is an emphasis scaling factor.

35-38. (canceled)

39. A computer program product in which a software code is stored in a computer readable medium, wherein said code realizes the following when being executed by a processor:
receiving a first part of an encoded audio signal;
determining at least one scaling factor based at least in part on the first part of the encoded audio signal;
scaling the first part of the encoded audio signal based at least in part on the at least one scaling factor to produce a scaled encoded audio signal; and
decoding the scaled encoded audio signal.

40. (canceled)
